(19) United States
(12) Patent Application Publication
(10) Pub. No.: US 2026/0067269 A1
(43) Pub. Date: Mar. 5, 2026

(54) APPLICATION PROGRAMMING INTERFACE SINGLE SIGN-ON MANAGEMENT

(71) Applicant: Hewlett Packard Enterprise Development LP, Spring, TX (US)

(72) Inventors: Pavan Kumar Challapalli, Bangalore (IN); Naveen Kondiparti, Bangalore (IN); Shiva Sarath Chandra Chintapalli, Bangalore (IN); Tathagata Roy, Bangalore (IN)

(21) Appl. No.: 18/953,213

(22) Filed: Nov. 20, 2024

(30) Foreign Application Priority Data
Sep. 4, 2024 (IN) 202441066917

(51) Int. Cl. H04L 9/40; G06F 9/54

(52) U.S. Cl. CPC H04L 63/083; G06F 9/547; H04L 63/0815

(57) ABSTRACT

The present disclosure provides a method implemented by a client for managing application programming interface (API) access. The method includes sending a first request to create a system session comprising a master API token, receiving a system session token in response, sending a second request to create a first application session for a first target application comprising the master API token, system session token, and a first identifier, receiving confirmation of the first application session creation, sending a third request to invoke a first API of the first target application comprising the master API token, system session token, first identifier, and a first payload, and receiving a first result from the first API in response to the third request. The method enables unified API access across multiple applications using a single master API token and system session token.

### BACKGROUND

Users in modern computing environments often access multiple applications and services across distributed systems. This typically involves authenticating with each application. Single sign-on (SSO) techniques allow users to authenticate once and gain access to multiple applications without re-entering credentials. SSO may enhance security by reducing the number of passwords users need to remember and manage. It may also improve user experience by streamlining access to various resources within an organization. SSO implementations often utilize protocols such as security assertion markup language (SAML), OAuth, or OpenID Connect to facilitate secure authentication and authorization. Additionally, SSO may integrate with directory services to centralize user management and access control.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a computing system, according to some implementations.

FIG. 2 is a block diagram of a single sign-on (SSO) configuration of a computing system, according to some implementations.

FIG. 3 is a sequence diagram of an application programming interface (API) SSO process, according to some implementations.

FIG. 4 is a flow diagram of an application session creation method, according to some implementations.

FIG. 5 is a flow diagram of an API invocation method, according to some implementations.

FIG. 6 is a flow diagram of a client API SSO method, according to some implementations.

FIG. 7 is a flow diagram of a IdP API SSO method, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

This disclosure describes a system and method for enabling single sign-on (SSO) features for application programming interface (API) access across multiple applications. It extends the capabilities of an identity provider (IdP) to act as an API gateway for SSO-integrated applications. A master API token is associated with a user, which may be used to access APIs of multiple target applications through a centralized identity provider service. This approach simplifies the process of managing multiple API keys for different applications, while also providing fine-grained access control policies and centralized key management.

The workflow of the system includes three main stages: application onboarding, master API token generation, and application API access. During the onboarding stage, applications are registered with the IdP by an administrator, specifying details such as the authentication workflow the applications support. Users may then generate a master API token through the IdP portal, which may be associated with specific access policies that define which applications may be accessed, as well as limits on sessions and API calls. The system supports various authentication workflows for the APIs of the target applications.

During the session management and API access stage, client applications may create sessions, authenticate with target applications, and invoke APIs of the target applications using the master API token. The system creates and manages application-specific sessions, handles API calls to target applications, and generates application-specific API keys when needed. This allows users to access multiple applications' APIs using a single authentication mechanism, similar to SSO access for browser-based interactions, while maintaining security and adhering to defined access policies.

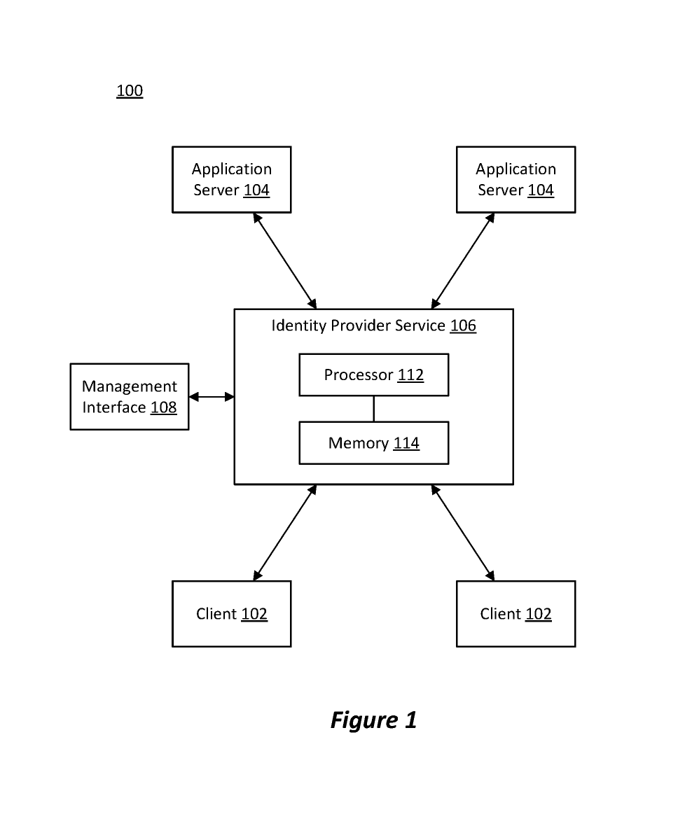

FIG. 1 is a block diagram of a computing system 100, according to some implementations. The computing system 100 may enable SSO for API access across multiple applications via an API gateway. The computing system 100 includes clients 102, application servers 104, an identity provider service 106, and a management interface 108.

The clients 102 may be host computing devices that interact with the application servers 104 to access the APIs of applications running on the application servers 104. The clients 102 may include desktop computers, laptops, mobile devices, or the like. During operation, the clients 102 initiate API requests and communicate with the application servers 104 to utilize their functionality and retrieve or manipulate data. Specifically, the clients 102 interact with the application servers 104 via the identity provider service 106. In some implementations, the clients 102 may store and manage master API tokens, create and maintain sessions, and handle communication protocols to interact with both the identity provider service 106 and the target application servers 104.

The application servers 104 may be host computing devices that host and provide access to various applications and their associated APIs. The application servers 104 may include desktop computers, servers, cloud-based systems, or other suitable computing platforms. During operation, the application servers 104 may receive API requests from the clients 102 via the identity provider service 106, process those requests, and return appropriate responses. The application servers 104 may host multiple applications, each of which may have its own API and authentication mechanisms. In some implementations, the application servers 104 may interact with the identity provider service 106 to validate authentication tokens and authorize API access requests by the clients 102.

The identity provider service 106 may be a central system or service that manages authentication, authorization, and API access for the clients 102 and the application servers 104. The identity provider service 106 may include one or more servers, a cloud-based infrastructure, or distributed computing resources. The identity provider service 106 extends typical IdP features to incorporate API gateway capabilities. The API gateway capabilities allow the identity provider service 106 to not only manage user authentication but also to control and facilitate API access across multiple applications.

During operation, the identity provider service 106 may receive requests from the clients 102 to create sessions, authenticate with target applications, and invoke APIs on the application servers 104. The identity provider service 106 may process these requests, validate credentials, manage tokens and sessions, and route API calls to the appropriate application servers 104. The identity provider service 106 interacts with the clients 102 and the application servers 104 to facilitate secure API access across multiple applications. The identity provider service 106 may also include databases or data stores to track user information, application configurations, tokens, and access policies.

The identity provider service 106 may include any suitable components. Suitable components include a processor, an application-specific integrated circuit, a microcontroller, memory, and the like. The identity provider service 106 may include a host computing device. For example, the identity provider service 106 may include a processor 112 and a memory 114. The memory 114 may be a non-transitory computer readable medium that stores programming for execution by the processor 112. One or more modules within the identity provider service 106 may be partially or wholly implemented as software and/or hardware for performing any functionality described herein. For example, they may be implemented as software, which is deployed to a host computing device using a suitable containerization technique. In some implementations, the identity provider service 106 may be part of a computing cluster, on which containers are deployed. Furthermore, although not separately illustrated, each of the clients 102 and the application servers 104 may also include similar components such as processors and memory for performing their respective functions within the computing system 100.

The management interface 108 may be a user interface that allows an administrator to configure and manage the identity provider service 106. It may be implemented as a web-based application or a console application, providing a centralized point of control for managing SSO features, API access policies, and application onboarding in the computing system 100. Through the management interface 108, an administrator may register new applications, define access policies, generate master API tokens, and monitor system activity.

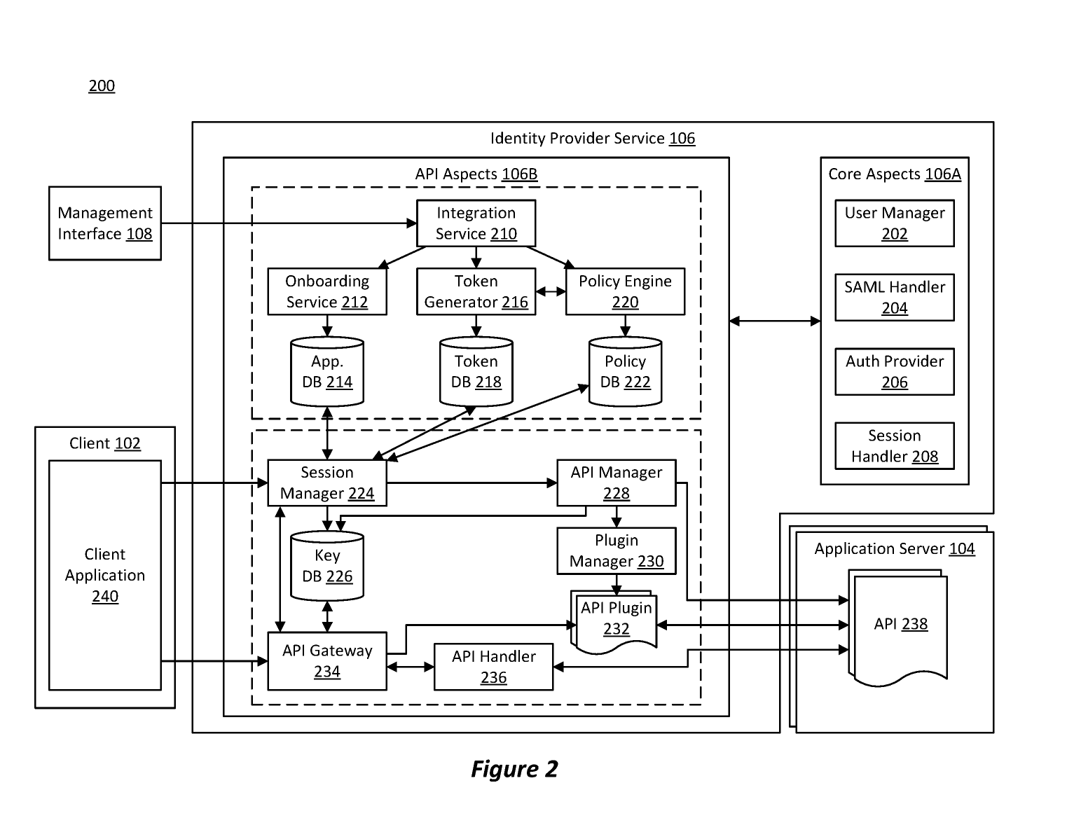

FIG. 2 is a block diagram of an API SSO configuration 200 of a computing system, according to some implementations. The API SSO configuration 200 will be described in conjunction with the computing system 100 of FIG. 1. The API SSO configuration 200 includes blocks, each of which may represent processes that may be performed by various components of the computing system 100. These blocks may correspond to software modules, services, or the like, implemented within the computing system 100. Specifically, each block may include instructions stored on a computer-readable medium that, when executed by a processor, cause the processor to perform the operations associated with that block.

The identity provider service 106 includes core aspects 106A and API aspects 106B. The core aspects 106A may represent the typical IdP features of the identity provider service 106, including user authentication, session management, and token handling. The core aspects 106A may be implemented using established identity management libraries or frameworks such as Keycloak, Auth0, IdentityServer, or the like. The API aspects 106B may be implemented as a plugin or extension to the identity provider service 106, adding API management capabilities on top of the core aspects 106A. The dashed lines enclosing blocks of the API aspects 106B may denote the boundaries of subsystems within the identity provider service 106.

The core aspects 106A may include the standard components of an Identity Provider (IdP), such as a user manager 202, which may handle user account management, including creation, modification, and deletion of user accounts. A SAML handler 204 may process SAML requests and responses, facilitating SAML-based authentication in the identity provider service 106. An authentication provider 206 may support various authentication methods in the identity provider service 106, potentially including username/password, multi-factor authentication, and the like. A session handler 208 may manage user sessions in the identity provider service 106, including creation, maintenance, and termination of sessions. The session handler 208 may associate a session with a session cookie. This session cookie may be used to maintain a user's authenticated state across multiple requests or interactions with the system. When creating a session, the session handler 208 may generate a unique session identifier and store it in the session cookie. The cookie may then be sent to the client and included in subsequent requests, allowing the identity provider service 106 to recognize and validate the user's session. The session handler 208 may update or refresh the session cookie as needed. When terminating a session, the session handler 208 may invalidate or delete the associated session cookie.

The API aspects 106B may include an integration service 210, which may coordinate the activities of other components during API SSO. An onboarding service 212 may handle the registration of new applications, potentially storing application information in an application database 214. A token generator 216 may create master API tokens, which may be stored in a token database 218. A policy engine 220 may manage access policies, which may be stored in a policy database 222. A session manager 224 may handle client sessions, interacting with a key database 226 to store session information. An API manager 228 may coordinate API requests, working with a plugin manager 230 and one or more API plugins 232 to handle application-specific API interactions. An API gateway 234 may serve as the entry point for API requests from a client 102, routing API requests to an API handler 236 for processing. The API handler 236 may interact with one or more application servers 104 to invoke APIs 238 of applications.

The databases 214, 218, 222, 226 may be implemented using various database management systems (DBMS) depending on the specific implementation of the identity provider service 106. These databases may be relational databases such as MySQL, PostgreSQL, or Oracle; NoSQL databases such as MongoDB or Cassandra; in-memory data stores such as Redis or Memcached; file stores; or the like. These databases may be part of the same data store or distributed across different data stores. In a single data store configuration, all the databases may be implemented as separate schemas, collections, or tables within a single DBMS. In a distributed configuration, each database may be implemented on a separate DBMS, potentially on different servers or cloud services.

The API SSO configuration 200 may interface with external components, including the management interface 108, which allows for system configuration and administration. Through this interface, an administrator may register new applications and generate master API tokens for users. When a new application is registered, the onboarding service 212 stores the application details in the application database 214. The token generator 216 creates master API tokens, which are associated with specific users and stored in the token database 218. These master API tokens are linked to access policies managed by the policy engine 220 and stored in the policy database 222. The policies may control which applications a user may access, apply rate limits, and enforce other restrictions.

A client 102 may execute a client application 240 that makes API requests using the identity provider service 106. The client 102 is provided a master API token, such as via the management interface 108, a script or automation tool, or the like. The client application 240 uses the master API token to authenticate once and gain access to the APIs 238 of multiple applications, which may be hosted on different application servers 104. The identity provider service 106 manages the authentication, session creation, and API access for the client 102, using the master API token to represent the authenticated user across multiple application sessions.

When the client 102 requests API access, the session manager 224 creates a session, storing session information in the key database 226. The API manager 228 then coordinates the API requests, using the plugin manager 230 and one or more API plugins 232 to handle application-specific API interactions.

The API gateway 234 serves as the entry point for API requests from the client 102, routing them to the API handler 236. The API handler 236 interacts with one or more application servers 104 to execute the API calls, potentially using an application-specific session or API key stored in the key database 226. The API handler 236 then receives the results from the application servers 104 and forwards them back to the client 102 through the API gateway 234. This process allows the identity provider service 106 to act as a secure intermediary, managing communication between the client 102 and the application servers 104. Throughout this process, the policy engine 220 enforces the access policies associated with the master API token, controlling which applications the client 102 may access and applying any defined restrictions. This organized approach allows the API SSO configuration 200 to provide centralized management of API access across multiple applications, simplifying the authentication process for clients while maintaining robust security and access control.

The workflow using the API SSO configuration 200 typically involves three main stages: application onboarding, master API token generation, and application API access. The process begins with application onboarding, where an administrator registers new applications with the identity provider service 106 through the management interface 108. During this stage, the onboarding service 212 stores application details in the application database 214, including information about the authentication workflow supported by each registered application.

The application onboarding process may involve an administrator providing specific details about an API 238 of an application to be integrated. These details may include the application identifier (e.g., name), login URL, and the like. Additionally, the administrator may specify a supported authentication workflow for the API 238. Examples of the authentication workflows may include simple redirect, unsolicited SAML response, IdP-initiated SAML, IdP-initiated OAuth authorization code grant, API identifier (ID) token, or the like (subsequently described in greater detail). The chosen authentication workflow may determine how the identity provider service 106 interacts with the API 238 during subsequent API access requests. In some implementations, additional parameters specific to the selected authentication workflow may be requested from the administrator via the management interface 108 during the onboarding process. The onboarding service 212 may process the provided information and store it in the application database 214, creating a catalog of registered applications. This catalog may serve as a reference for the identity provider service 106 when handling API access requests and managing authentication workflows.

Following application onboarding, a master API token may be generated for a user through the identity provider service 106. The token generator 216 creates these master API tokens, which are associated with specific users and stored in the token database 218. To obtain a master API token, the end user may log into a portal of the identity provider service 106 (e.g., the management interface 108) using their credentials. Once authenticated, the user may navigate to a dedicated interface for generating master API tokens. This interface may allow the user to specify a name for the token and configure associated access policies. In some implementations, the token and associated access policies may be generated by an administrator, and the user may access the previously generated token via a portal of the identity provider service 106 (e.g., the management interface 108).

Each master API token may be linked to access policies managed by the policy engine 220 and stored in the policy database 222. These policies may define which applications may be accessed by a master API token, set limits on sessions and API calls by the master API token, and enforce other restrictions to ensure secure and controlled access. The access policy may include an application list, specifying which applications the master API token is authorized to access. Additionally, the access policy may set a maximum number of concurrent sessions that may be created using the master API token, as well as set rate limits to control the frequency of API calls.

The generation of the master API token may involve the creation of a random, unique identifier that serves as the token value. This token value may be displayed to the user upon generation, allowing them to copy and securely store it for future use in client applications. The master API token may be implemented in various formats, such as a single random API token, OAuth client credentials, or the like. In the case of OAuth client credentials, scopes may be defined to invoke the APIs specified in the access policy.

Once generated, the master API token becomes the primary authentication mechanism for a client 102 to access multiple application APIs 238 through the identity provider service 106. This approach simplifies token management for users, as they no longer need to handle individual tokens for individual application APIs 238. Instead, the master API token, in conjunction with its associated access policy, provides a centralized and controlled method for accessing multiple applications' APIs 238. The token may be used by a client 102 in subsequent API calls to create sessions, authenticate with target applications, and invoke APIs 238, all while adhering to the defined access policies and security measures implemented by the identity provider service 106.

Following master API token generation, application API access may be performed. In this stage, a client 102 may use the master API token to actually invoke an API 238. When a client 102 initiates an API request, it uses the master API token to authenticate with the identity provider service 106. The session manager 224 creates a session and stores the information in the key database 226. The API manager 228 then coordinates the API requests, utilizing the plugin manager 230 and API plugins 232 to handle application-specific API interactions. The API gateway 234 serves as the entry point for these requests, routing them to the API handler 236, which interacts with the appropriate application servers 104 to execute the API calls. This process allows users to access multiple applications' APIs 238 using a single authentication, similar to SSO access for browser-based interactions.

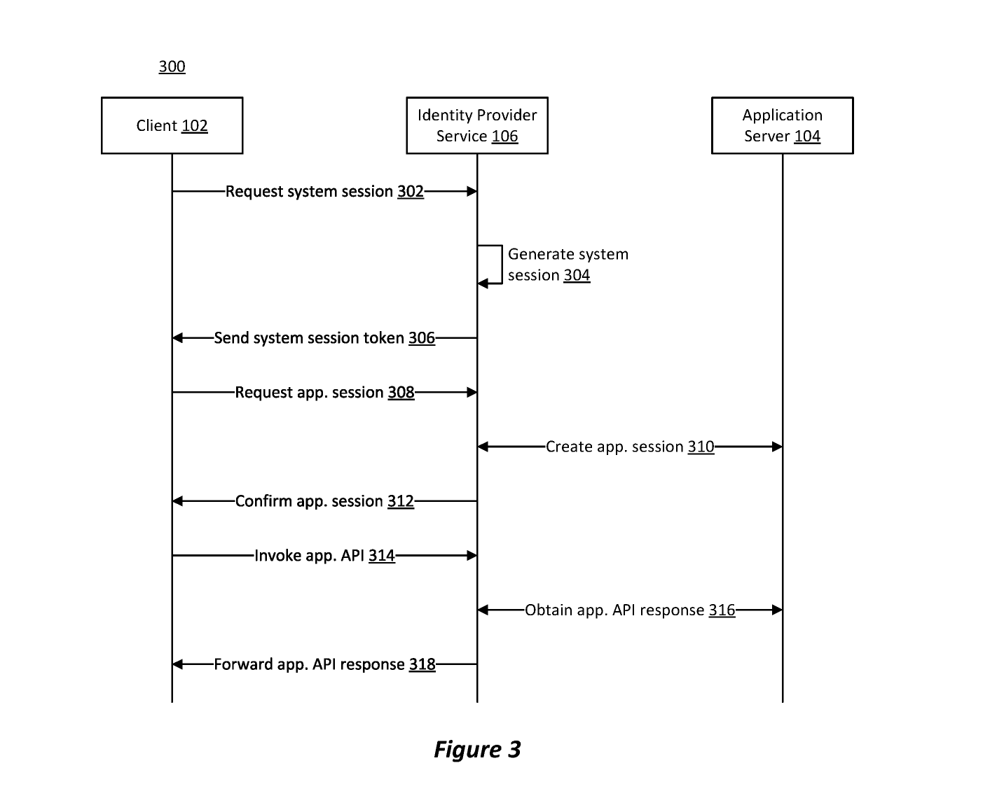

FIG. 3 is a sequence diagram of an API SSO process 300, according to some implementations. The API SSO process 300 will be described in conjunction with the computing system 100 of FIG. 1 and the API SSO configuration 200 of FIG. 2. The API SSO process 300 may be performed in a computing system during the third stage (application API access) of the aforementioned workflow. FIG. 3 outlines the sequence of steps and interactions between a client 102, an application server 104, and the identity provider service 106 during this stage. Although illustrated in a particular sequence, it should be appreciated that the steps of the API SSO process 300 may be performed in any suitable sequence.

In step 302, the client 102 (e.g., running a client application 240) initiates a system session creation process. The client 102 sends a first request to create a system session to the identity provider service 106. This request may be a hypertext transfer protocol (HTTP) request that includes the master API token that was previously generated for the user. The master API token may be included in an authorization header of the HTTP request. The master API token serves as the primary authentication credential for accessing multiple applications through the identity provider service 106. The master API token may be in a single (e.g., bearer) token format or a client credential format. The client 102 initiates this request to establish a system session for accessing the identity provider service 106.

In step 304, the identity provider service 106 receives the create system session request and processes it. The session manager 224 component of the identity provider service 106 validates the master API token against the token database 218. It also checks the associated policy in the policy database 222 to confirm that the request complies with any restrictions, such as the maximum number of allowed sessions. If the token is valid and the policy allows, the session manager 224 creates a new system session for the client 102.

As part of creating the new system session, the session manager 224 may generate a unique system session token. This system session token may be a random string or a cryptographically secure identifier that represents the newly created session. In some implementations, the session manager 224 may also create a session cookie, which may contain the system session token or other session-related information. The session cookie may be designed to be stored on the client 102 and sent with subsequent requests to maintain the session state. The session manager 224 may then store the session information in the token database 218. The stored session information may include the system session token, client identifier, session expiration time, and any other relevant session metadata. In some implementations, the session cookie may also be stored in the database, allowing the identity provider service 106 to validate incoming requests against stored session data.

In step 306, the identity provider service 106 sends the generated system session token back to the client 102. The system session token may be included in a response body or as part of a header, such as a "Set-Cookie" header if a session cookie is being used. The client 102 may then store this system session token locally, either in memory or in a secure storage mechanism, for use in subsequent requests. The system session token serves as a temporary credential that allows the client 102 to maintain its authenticated state with the identity provider service 106 throughout the duration of the system session, in which one or more APIs 238 may be accessed.

In step 308, the client 102 initiates an application session creation process. The client 102 sends a second request to create a first application session for a first target application. This is an HTTP request that includes several pieces of information, such as the master API token, the system session token (which was obtained in the previous steps), and a first identifier for the first target application (such as the application name). In some implementations, the request may also include additional parameters for obtaining an API key specific to the target application, referred to as plugin parameters. The client 102 initiates this request to establish an application session for accessing an API 238 of a desired application.

In step 310, the identity provider service 106 communicates with the application server 104 to create the application session. The session manager 224 validates the master API token and the system session token provided in the request. If the tokens are invalid, the identity provider service 106 responds to the application server 104 with an error. If the tokens are valid, the policy engine 220 checks the associated access policy to confirm the request complies with any defined restrictions or limits on the master API token (e.g., usage limits, session limits, etc.). If the access policy has not been complied with, the identity provider service 106 responds to the application server 104 with an error. If the access policy has been complied with, the API manager 228 then initiates an application session with the target application server 104. This process may vary depending on the authentication workflow supported by the application, as specified during the onboarding process. The authentication workflow may involve simple redirect, unsolicited SAML response, IdP-initiated SAML, IdP-initiated OAuth authorization code grant, API ID token, or another workflow. Depending on the authentication workflow, the identity provider service 106 may obtain an application-specific API key (from the application server 104) if appropriate parameters were provided in the request. The API manager 228 stores information associating the newly created application session with the master API token and system session token in the key database 226.

Depending on the authentication workflow, the identity provider service 106 may interact with the application server 104 to complete the authentication process, which may involve redirects, token exchanges, or other protocol-specific steps. For example, the API manager 228 may retrieve an IdP session cookie associated with the system session token from the key database 226 and use it to create a REST session. The API manager 228 then uses the REST session to initiate application session creation using, e.g., IdP-initiated SAML or OAuth, depending on the authentication workflow configured for the specific application server 104. Since the IdP session cookie is available in the REST session, the application server 104 authenticates the request and sends an application-specific cookie back to the API manager 228. Upon receiving this application-specific cookie, the API manager 228 stores the master API token, system session token, application session information (including the application-specific cookie), and application identifier (e.g., name) in the key database 226 for future use.

In some implementations, if the request included plugin parameters, the identity provider service 106 may utilize API plugins to handle application-specific API interactions. For example, API plugins may be used to generate credentials for supported API access mechanisms, such as API keys, tokens, service accounts, or the like. An API plugin 232 may be selected based on the target application. The API manager 228 may provide the API request to the appropriate API plugin 232 via the plugin manager 230. The API plugin 232 may then invoke the API 238 of the target application using the application session information and any plugin parameters. The API plugin 232 may be specific to the application, containing custom logic to obtain an API key, token, or service account as supported by the application, using the application session and plugin parameters. Additionally, the API plugin 232 may handle any key rotation or expiration policies of the target application. The API plugin 232 may retrieve an API key associated with the application session from the application server 104. Upon receiving the API key, the API plugin 232 may store it in the key database 226, mapping it to the application session, application identifier (e.g., name), system session token, and master API token for future use. This approach may allow for flexible handling of different application-specific API interaction techniques.

In step 312, the application server 104 sends confirmation of creation of the first application session back to the client 102. For example, the API manager 228 may relay a success message through the various components of the identity provider service 106 and back to the client 102, indicating the successful completion of the application session creation and API key retrieval process. This confirmation indicates that the application session has been successfully established and associated with the client's master API token and system session token. At this point, the client 102 has established an application session with the application server 104 using a single master API token. The client 102 may now use this established application session to make API calls to the target application server 104 without having to manage an individual key for the target application. This approach effectively extends single sign-on capabilities to API access across the various applications integrated with the identity provider service 106.

In step 314, the client 102 sends a third request to invoke a first API 238 of the first target application to the identity provider service 106. This is an HTTP request that includes the master API token (e.g., in the authorization header), and a data payload containing the system session token, the first identifier for the first target application (e.g., application name), and a first payload for the first API 238. The API payload contains specific details about the API call, such as the method, path, query parameters, and any additional payload data required for the invocation of the API 238 (e.g., HTTP POST payload, HTTP GET query parameters, etc.).

In step 316, the identity provider service 106 interacts with the application server 104 to process the API request. The API gateway 234 within the identity provider service 106 receives the request and validates the master API token and system session token. The policy engine 220 then checks if the request complies with the access policy associated with the master API token. If the validation is successful, the API gateway 234 attempts to obtain an API key associated with the system session token and application identifier (e.g., name) from the key database 226.

If an API key is found, the request is forwarded to the corresponding API plugin 232 along with the API key and payload. The API plugin 232 handles the invocation of the API 238 using the API key and payload. If an API key is not found, the request is forwarded to the API handler 236 along with the application session information. The API handler 236 creates a REST session, loads the application session context with the application domain (e.g., session cookies), and invokes the application's API 238 using the provided API payload and the REST session. In either case, the result of the invocation is returned from the API 238 to the API gateway 234.

In step 318, the identity provider service 106 forwards the API response from the application server 104 back to the client 102. Specifically, the identity provider service 106 forwards the result from the first API 238 of the first target application back to the client 102. The response contains the result of the API call executed on the target application. The response from either the API handler 236 or the API plugin 232 is passed back to the API gateway 234. The API gateway 234 returns the API response to the client 102, completing the API invocation process.

The API SSO process 300 may be extended to allow a client 102 to call multiple application APIs 238 using the master API token for authentication. After completing the initial system session creation (steps 302-306), the client 102 may repeat steps 308-318 for each target application API 238 it wishes to access. For example, the client 102 may send a fourth request to create a second application session (step 308) for a second target application using the same master API token and system session token, but with a second identifier for the second target application. The identity provider service 106 may then create separate application sessions for each target application (step 310), storing the relevant information in the key database 226. Once the application sessions are established, the client 102 may invoke APIs 238 for multiple applications (step 314) by sending requests that include the master API token, system session token, and the appropriate application identifier (e.g., name) and API payload for each target application. The identity provider service 106 may process these requests (steps 316-318) using the stored application session information, effectively allowing the client 102 to access multiple application APIs 238 through a single authentication mechanism.

Additional steps (not separately illustrated) may be performed. The client 102 may terminate an application session with the identity provider service 106, to end a specific application session when it is no longer needed. To accomplish this, the client 102 may send a termination request to the identity provider service 106 that includes the master API token, the system session token, and the application identifier (e.g., name). Upon receiving this request, the session manager 224 may validate the provided tokens against the token database 218 and the key database 226. If the tokens are valid, the session manager 224 may proceed to delete the associations between the system session token, application identifier (e.g., name), and any related application-specific session information from the key database 226. This may effectively terminate the application session, freeing up resources and prohibiting the application session from being used for more API calls. After successfully terminating the application session, the identity provider service 106 may then send a confirmation of the successful termination back to the client 102. Furthermore, the client 102 may log out of the application before terminating the application session.

Furthermore, the client 102 may terminate a system session with the identity provider service 106, to end the system session when it is no longer needed. To accomplish this, the client 102 may send a termination request to the identity provider service 106. This request may include the master API token and the system session token associated with the system session to be terminated. Upon receiving the termination request, the session manager 224 of the identity provider service 106 may validate the provided tokens against the token database 218. If the tokens are valid, the session manager 224 may proceed to delete the associations between the system session token, master API token, and any related session information from the key database 226. This may effectively terminate the system session, freeing up resources and preventing the system session from being used for more API calls. After successfully terminating the system session, the identity provider service 106 may then send a confirmation of the successful termination back to the client 102.

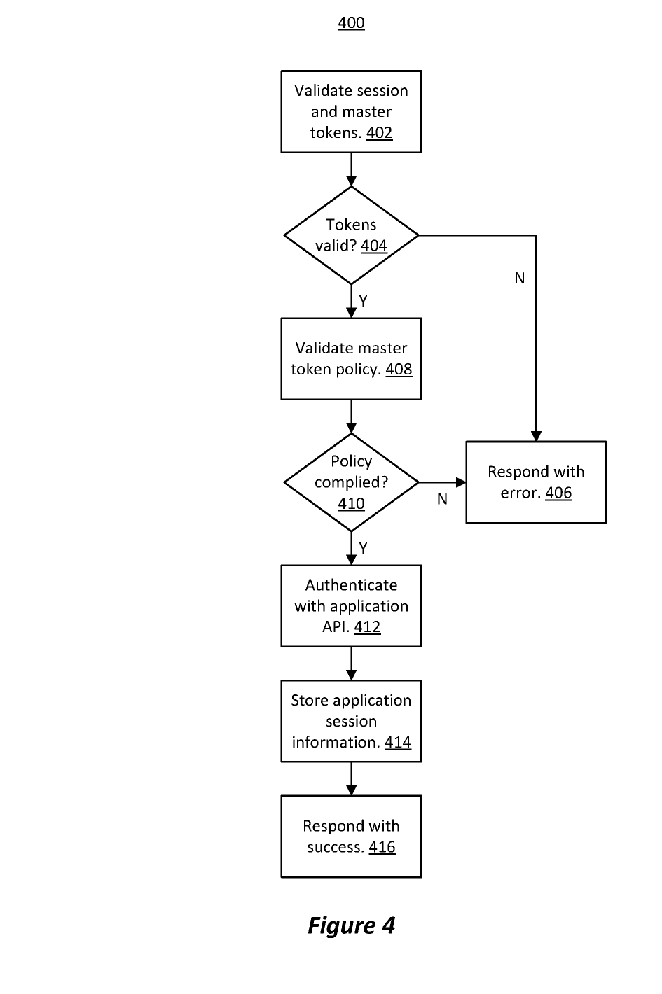

FIG. 4 is a flow diagram of an application session creation method 400, according to some implementations. The application session creation method 400 will be described in conjunction with the computing system 100 of FIG. 1 and the API SSO configuration 200 of FIG. 2. The application session creation method 400 may be implemented by the computing system 100. Specifically, the identity provider service 106 may perform the application session creation method 400, such as during step 310 (see FIG. 3).

The identity provider service 106 may perform a step 402 of validating the system session and master API tokens in an application session creation request. Validation may involve checking the validity of the system session token and master API token against the token database 218.

The identity provider service 106 may perform a step 404 of determining if the tokens are valid. If the tokens are not valid, the identity provider service 106 may perform a step 406 of responding to the client 102 with an error. For example, the identity provider service 106 may send an error message back to the client 102, indicating that the provided tokens are invalid. If the tokens are valid, the identity provider service 106 may perform a step 408 of validating the master API token against its access policy (if any). This may include the policy engine 220 checking the policy database 222 to confirm that the request complies with any restrictions or limits associated with the master API token, such as usage limits or session limits.

The identity provider service 106 may perform a step 410 of determining if the policy for the master API token has been complied with. If the policy was not complied with, the identity provider service 106 may perform a step 406 of responding to the client 102 with an error (as previously described). If the policy was complied with, the identity provider service 106 may perform a step 412 of authenticating with the API 238 of the target application. This may include initiating an application session with the target application server 104 using the authentication workflow specified during the onboarding process for the application.

One of multiple authentication workflows may be utilized to initiate the application session with the target application server 104. The authentication workflows may include simple redirect, unsolicited SAML response, IdP-initiated SAML, IdP-initiated OAuth authorization code grant, or API ID token. Each of these will be described.

In some implementations, the simple redirect application authentication workflow involves a series of HTTP redirects to authenticate a user and establish an application session. The process may begin with the API manager 228 retrieving a login URL for the specified application from the application database 214. The API manager 228 may then request an Identity Provider (IdP) session cookie from the session handler 208 within the core aspects 106A of the identity provider service 106, which generates and provides the cookie containing authentication information. With this cookie, the API manager 228 may create a REST session and load the IdP session cookie for the IdP domain in the REST session. The API manager 228 may then invoke the application's login URL, triggering a series of HTTP redirects. The application server 104 may first redirect to an external IdP, which in turn may initiate an authentication request. Since the IdP session cookie is already available, the external IdP may recognize the authenticated state and send an authenticated response back to the application server 104. Upon receiving the authenticated response, the application server 104 may perform a final HTTP redirect to its landing page, signifying the completion of the authentication process. The API manager 228 may then retrieve the application session cookie from the landing page of the application server 104 and store it in the key database 226 for future use.

In some implementations, the unsolicited SAML response application authentication workflow may be utilized for applications that are SAML-integrated directly with the identity provider service 106 and accept unsolicited SAML responses for authentication. The process may begin with the API manager 228 requesting and retrieving an IdP session cookie from the session handler 208 within the core aspects 106A of the identity provider service 106, which it then loads for the IdP domain of a request. The API manager 228 may then initiate an unsolicited SAML response for the application server 104 by sending a request to the SAML handler 204 within the core aspects 106A, which responds with a callback URL and SAML assertion for the application server 104. Using this information, the API manager 228 may initiate the unsolicited SAML response to the SAML callback URL of the application server 104. Upon receiving and processing this response, the application server 104 may consider it as a successful authentication and perform a redirect to its landing page. Finally, the API manager 228 may retrieve the application session cookie from the landing page of the application server 104 and store it in the key database 226 for future use, completing the authentication process without requiring a user-initiated SAML request.

In some implementations, the IdP-initiated SAML application authentication workflow may be utilized for applications that are SAML-integrated directly with the identity provider service 106 and support IdP-initiated authentication. The process may begin with the API manager 228 retrieving the IdP session cookie from the session handler 208 within the core aspects 106A of the identity provider service 106, which it then loads for the IdP domain of a request. The API manager 228 may then obtain application data from the SAML handler 204 within the core aspects 106A for invoking the IdP-initiated SAML authentication for the application server 104, using the application identifier and IdP session cookie. In response, it may receive the application data for the authentication process. The API manager 228 may then create a REST session with the IdP session cookie and trigger the IdP-initiated SAML by sending a request to the application server 104. Upon receiving this request, the application server 104 may generate a SAML request and send it to the SAML handler 204 within the core aspects 106A. Due to the presence of the IdP session cookie in the session, authentication may succeed, and the SAML handler 204 within the core aspects 106A may send the appropriate SAML assertion back to the application server 104. The application server 104 may then perform a redirect to its landing page, signifying successful authentication. Finally, the API manager 228 may retrieve the application session cookie from the landing page of the application server 104 and store it in the key database 226 for future use, completing the IdP-initiated SAML process.

In some implementations, the IdP-initiated OAuth authorization code grant application authentication workflow may be utilized for applications that support OAuth and allow IdP-initiated authentication. The process may begin with the API manager 228 retrieving the application session URI from the key database 226 for the specified application identifier. The API manager 228 may then request and receive the IdP session cookie from the session handler 208 within the core aspects 106A of the identity provider service 106. Next, the API manager 228 may look up OAuth parameters for the application from the authentication provider 206 within the core aspects 106A, which returns the OAuth parameters. The API manager 228 may then create a REST session and load the IdP session cookie for the IdP domain. The OAuth process may be initiated with the specified OAuth parameters, such as client_id, redirect_uri, response_type, scope, and state. The authentication provider 206 within the core aspects 106A may respond with a redirection request to a redirect URI with an authorization code. The API manager 228 may obtain the redirection request from the REST session and collect the authorization code. The API manager 228 may then use the token endpoint obtained from the core aspects 106A (as part of OAuth parameters) with the authorization code to retrieve an access token. With the access token, the API manager 228 may invoke the session endpoint of the application server 104, including the access token in the bearer header. The application server 104 may validate the access token and, if successful, perform a redirection to its landing page. Finally, the API manager 228 may retrieve the application session cookie from the landing page of the application server 104 and store it in the key database 226 for future use, completing the IdP-initiated OAuth authorization code grant process.

In some implementations, the API ID token application authentication workflow may be utilized. This workflow may be a unified API access mechanism that is agnostic to the underlying SSO integration technology, whether OAuth, SAML, or another technology. The process may begin with the API manager 228 retrieving the application's API key endpoint from the application database 214, which may be one of the additional details provided during application onboarding. The API manager 228 may then generate an API ID token for the application using the system session token and store it in the token database 218. This API ID token is specifically created for the target application and serves as a temporary credential for obtaining an API key. Next, the API manager 228 may invoke the API key endpoint of the application server 104, including the API ID token as a bearer token (e.g., in an authorization header). Upon receiving the request, the application server 104 may validate the source as the identity provider service 106 from the origin header and invoke an introspection endpoint of the authentication provider 206 within the core aspects 106A to check the validity of the API ID token. This introspection process allows the application server 104 to verify the authenticity and integrity of the API ID token with the identity provider service 106. When the authentication provider 206 within the core aspects 106A receive the introspection request with the API ID token (and potentially any other suitable parameters), they may relay the request to the API manager 228 for validation. The API manager 228 may then validate the API ID token from the token database 218 and generate a successful response to the application server 104 with the user information (e.g., system session token) associated with the API ID token. Once the application server 104 receives a successful response, it may generate and respond with an API key. Finally, the API manager 228 may store the application's API key in the key database 226 for future use, completing the API ID token-based authentication process. This approach provides a standardized method for API key retrieval across various applications, regardless of their SSO integration method, further simplifying the API access process in heterogeneous application environments.

The identity provider service 106 may perform a step 414 of storing the application session information. Storing the application session information may include saving the relevant session data in the key database 226. This data may include the master API token, system session token, application session information (including the application-specific cookie), and application identifier (e.g., name) for future use.

The identity provider service 106 may perform a step 416 of responding with a success message. This may include sending a confirmation back to the client 102, indicating that the application session has been successfully created and associated with the client's master API token and system session token.

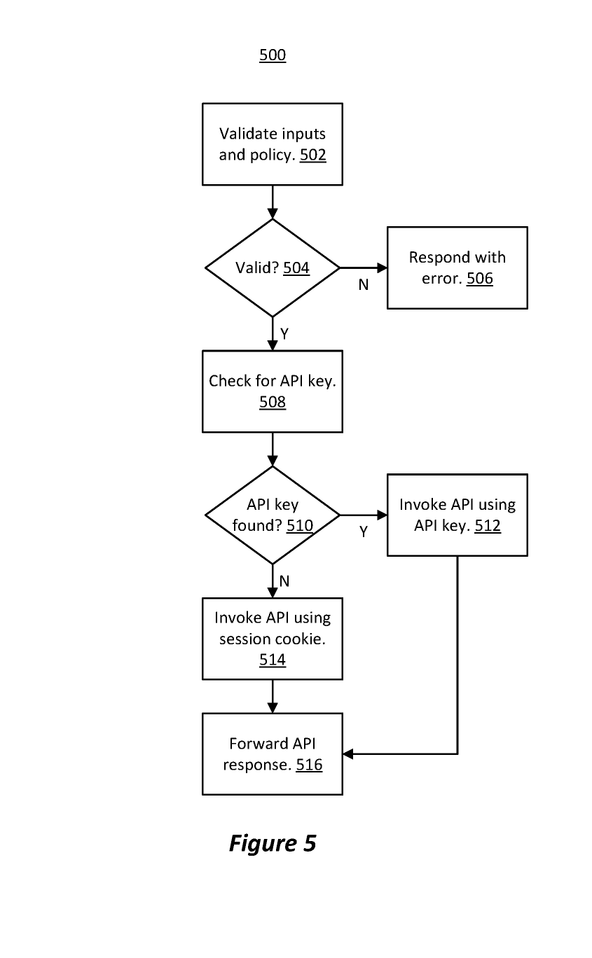

FIG. 5 is a flow diagram of an API invocation method 500, according to some implementations. The API invocation method 500 will be described in conjunction with the computing system 100 of FIG. 1 and the API SSO configuration 200 of FIG. 2. The API invocation method 500 may be implemented by the computing system 100. Specifically, the identity provider service 106 may perform the API invocation method 500, such as during step 316 (see FIG. 3).

The identity provider service 106 may perform a step 502 of validating inputs in the API invocation request and confirming any policy for the master API key has been complied with. This may include performing similar processes as those described with respect to steps 402 and 408 of FIG. 4. It may involve checking the validity of the provided inputs, such as tokens and application identifiers, as well as verifying compliance with associated policies.

The identity provider service 106 may perform a step 504 of determining if the inputs and policy are valid. This may include performing similar processes as those described with respect to steps 404 and 410 of FIG. 4, including checking for token validity and policy compliance. If the inputs or policy are not valid, the identity provider service 106 may perform a step 506 of responding to the client 102 with an error. For example, the identity provider service 106 may send an error message back to the client 102, indicating that the provided inputs are invalid or that the policy has not been complied with.

If the inputs and policy are valid, the identity provider service 106 may perform a step 508 of checking for an API key for the specified application. This may include searching the key database 226 for an API key associated with the current session and target application. In some implementations, the key database 226 may store mappings between system session tokens, application identifiers, and corresponding API keys. The identity provider service 106 may use the system session token and application identifier provided in the request to query the key database 226. If an API key was previously obtained for the current session and target application, it may be retrieved from the key database 226.

The identity provider service 106 may perform a step 510 of determining if the API key was found. If an API key was found, the identity provider service 106 may perform a step 512 of invoking the API 238 using the API key. This may include using the retrieved API key to authenticate and access the target API via the API plugin 232. If an API key was not found, the identity provider service 106 may perform a step 514 of invoking the API using a session cookie. This may involve using the stored application session information to authenticate and access the API 238 via the API handler 236. In some implementations, the stored application session information may include a session cookie or other authentication data obtained during the initial application session creation. The identity provider service 106 may retrieve this session information from the key database 226 or another suitable storage location. The API handler 236 may create a REST session and load the application session cookies into the REST session.

In either case, the API 238 is invoked by sending the API payload to the API 238. The application server 104 processes the API request and returns a response. This response is then passed back up through the chain - either through the API plugin 232 or the API handler 236, depending on which path was taken. The identity provider service 106 may perform a step 516 of forwarding the API response to the client 102.

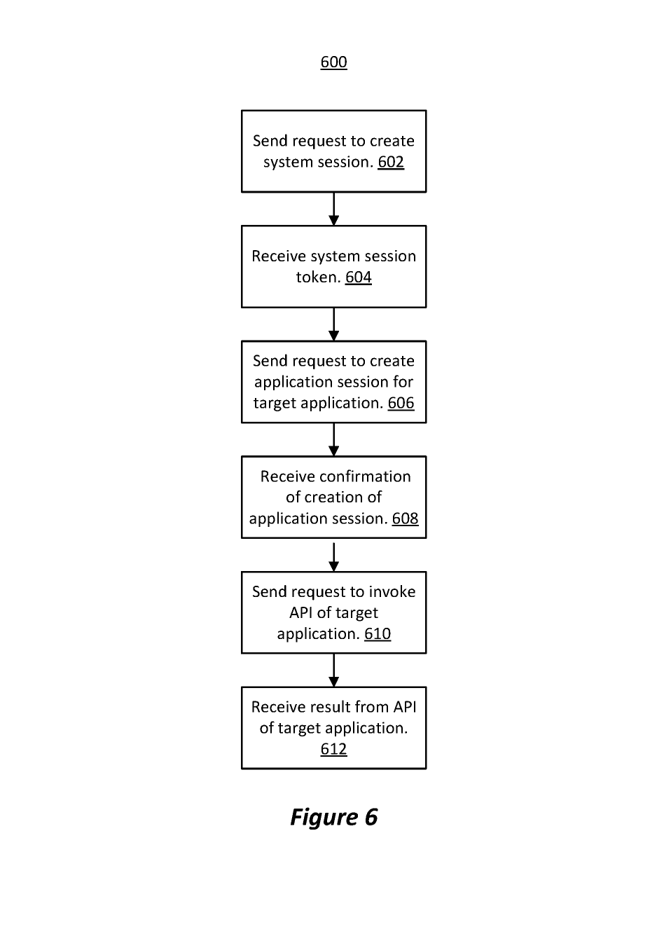

FIG. 6 is a flow diagram of a client API SSO method 600, according to some implementations. The client API SSO method 600 will be described in conjunction with the computing system 100 of FIG. 1 and the API SSO configuration 200 of FIG. 2. The client API SSO method 600 may be implemented by the computing system 100. Specifically, the client 102 may perform the client API SSO method 600.

The client 102 may perform a step 602 of sending a first request to create a system session, the first request including a master application programming interface (API) token. The first request is sent to the identity provider service 106 and initiates the process of establishing a system-wide session for API access through the identity provider service 106. The master API token may be a bearer token or a client credential token.

The client 102 may perform a step 604 of receiving a system session token for the system session in response to the first request. The system session token is received from the identity provider service 106. It may be generated by the identity provider service 106, and serves as a temporary credential for the duration of the system session.

The client 102 may perform a step 606 of sending a second request to create a first application session for a first target application, the second request including the master API token, the system session token, and a first identifier for the first target application. The second request is sent to the identity provider service 106, and establishes a session specific to the first target application on the application server 104.

The client 102 may perform a step 608 of receiving confirmation of creation of the first application session in response to the second request. The confirmation is received from the identity provider service 106. The confirmation indicates that the application-specific session has been successfully established.

The client 102 may perform a step 610 of sending a third request to invoke a first API 238 of the first target application, the third request including the master API token, the system session token, the first identifier for the first target application, and a first payload for the first API 238. The third request is sent to the identity provider service 106, and initiates the actual API call to the target application through the identity provider service 106. The first payload for the first target application may include a name for a method of the first API 238, a path for the method of the first API 238, a parameter for the method of the first API 238, and any additional payload inputs called for by the first API 238.

The client 102 may perform a step 612 of receiving a first result from the first API 238 of the first target application in response to the third request. The result is received from the identity provider service 106, and completes the API call process, with the client 102 receiving the requested data or confirmation of the requested action via the identity provider service 106.

In some implementations, the client 102 may perform additional steps. These may include sending a fourth request to terminate the first application session, the fourth request including the master API token, the system session token, and the first identifier for the first target application, and receiving confirmation of termination of the first application session in response to the fourth request. The client 102 may also send a fifth request to terminate the system session, the fifth request including the master API token and the system session token, and receive confirmation of termination of the system session in response to the fifth request. These requests may be sent to the identity provider service 106, and the confirmations may be received from the identity provider service 106.

In some implementations, the client 102 may send a fourth request to create a second application session for a second target application, the fourth request including the master API token, the system session token, and a second identifier for the second target application. The client 102 may then receive confirmation of creation of the second application session in response to the fourth request, the second target application being different from the first target application. Following this, the client 102 may send a fifth request to invoke a second API 238 of the second target application, the fifth request including the master API token, the system session token, the second identifier for the second target application, and a second payload for the second API 238. The client 102 may then receive a second result from the second API 238 of the second target application in response to the fifth request. These requests may be sent to the identity provider service 106, and the confirmations and results may be received from the identity provider service 106.

In some implementations, the master API token may be associated with a rate limit and a session limit, managed by the identity provider service 106. The third request and the fifth request may be sent based on the rate limit, while the second request and the fourth request may be sent based on the session limit. In some implementations, the second request may further include parameters for obtaining an API key for the first target application, which may be processed by the identity provider service 106 to obtain the API key.

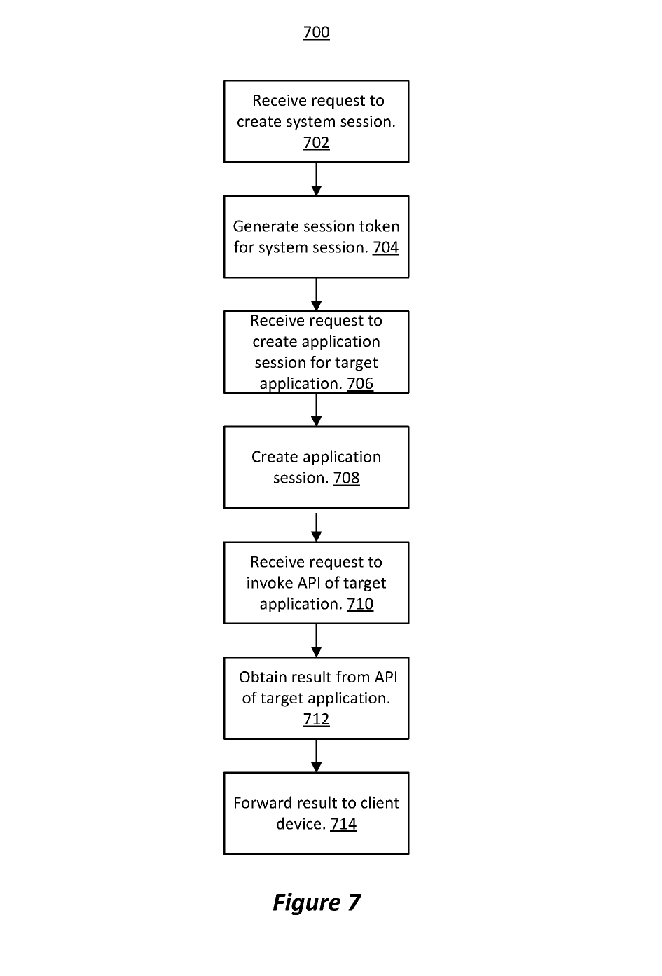

FIG. 7 is a flow diagram of an IdP API SSO method 700, according to some implementations. The IdP API SSO method 700 will be described in conjunction with the computing system 100 of FIG. 1 and the API SSO configuration 200 of FIG. 2. The IdP API SSO method 700 may be implemented by the computing system 100. Specifically, the identity provider service 106 may perform the IdP API SSO method 700.

The identity provider service 106 may perform a step 702 of receiving a first request to create a system session from a client 102, the first request including a master application programming interface (API) token. The first request initiates the process of establishing a system-wide session for API access by the client 102. The identity provider service 106 may also generate the master API token for a user and associate the master API token with a rate limit and a session limit. The master API token may be a bearer token or a client credential token.

The identity provider service 106 may perform a step 704 of generating a system session token for the system session in response to the first request. The system session token serves as a temporary credential for the duration of the system session.

The identity provider service 106 may perform a step 706 of receiving a second request to create a first application session for a first target application from the client 102, the second request including the master API token, the system session token, and a first identifier for the first target application. The second request establishes a session specific to the first target application. The second request may further include parameters for obtaining an API key for the first target application.

The identity provider service 106 may perform a step 708 of creating the first application session in response to the second request. The creation of the first application session involves validating the master API token and the system session token for the second request, initiating the first application session with the first target application in response to validating the master API token and the system session token, and storing information associating the first application session with the master API token and the system session token. In some implementations, initiating the first application session may include authenticating with the first API 238 through a simple redirect authentication workflow, an unsolicited security assertion markup language response authentication workflow, an identity provider initiated security assertion markup language authentication workflow, an identity provider initiated OAuth authorization code grant authentication workflow, or an API identifier token authentication workflow. When parameters for obtaining an API key are provided, creating the first application session may further include obtaining the API key based on the parameters.

The identity provider service 106 may perform a step 710 of receiving a third request to invoke a first API 238 of the first target application from the client 102, the third request including the master API token, the system session token, the first identifier for the first target application, and a first payload for the first API 238. The third request initiates the actual API call to the target application. The first payload for the first target application may include a name for a method of the first API 238, a path for the method of the first API 238, a parameter for the method of the first API 238, and any additional payload inputs called for by the first API 238.

The identity provider service 106 may perform a step 712 of obtaining a first result from the first API 238 of the first target application in response to the third request. The result is obtained by invoking the first API 238 based on the stored information. When an API key is obtained, obtaining the first result from the first API 238 of the first target application may include validating the master API token and the system session token for the third request, and invoking the first API 238 based on the API key and the first payload.

The identity provider service 106 may perform a step 714 of forwarding the first result to the client 102. The forwarding of the first result completes the API call process.

In some implementations, the identity provider service 106 may perform additional steps. These may include generating the master API token for a user and associating the master API token with a rate limit and a session limit.

The integrated approach to identity management and API access control may achieve advantages. By using a single master API token to access multiple application APIs, the system simplifies API access management for both users and administrators. It reduces the complexity of managing multiple API keys for different applications, while still maintaining fine-grained control over access rights. The centralized nature of the system also enhances security by providing a single point of control for authentication and authorization across multiple applications, making it easier to implement and enforce consistent security policies.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A method, implemented by a client, the method comprising:
sending a first request to create a system session, the first request comprising a master application programming interface (API) token;
receiving a system session token for the system session in response to the first request;
sending a second request to create a first application session for a first target application, the second request comprising the master API token, the system session token, and a first identifier for the first target application;
receiving confirmation of creation of the first application session in response to the second request;
sending a third request to invoke a first API of the first target application, the third request comprising the master API token, the system session token, the first identifier for the first target application, and a first payload for the first API; and
receiving a first result from the first API of the first target application in response to the third request.

2. The method of claim 1, further comprising:
sending a fourth request to terminate the first application session, the fourth request comprising the master API token, the system session token, and the first identifier for the first target application; and
receiving confirmation of termination of the first application session in response to the fourth request.

3. The method of claim 2, further comprising:
sending a fifth request to terminate the system session, the fifth request comprising the master API token and the system session token; and
receiving confirmation of termination of the system session in response to the fifth request.

4. The method of claim 1, further comprising:
sending a fourth request to create a second application session for a second target application, the fourth request comprising the master API token, the system session token, and a second identifier for the second target application, the second target application being different from the first target application;
receiving confirmation of creation of the second application session in response to the fourth request;
sending a fifth request to invoke a second API of the second target application, the fifth request comprising the master API token, the system session token, the second identifier for the second target application, and a second payload for the second API; and
receiving a second result from the second API of the second target application in response to the fifth request.

5. The method of claim 4, wherein the master API token is associated with a rate limit, and wherein the third request and the fifth request are sent based on the rate limit.

6. The method of claim 4, wherein the master API token is associated with a session limit, and wherein the second request and the fourth request are sent based on the session limit.

7. The method of claim 1, wherein the first payload for the first target application comprises a name for a method of the first API, a path for the method of the first API, and a parameter for the method of the first API.

8. The method of claim 1, wherein the second request further comprises parameters for obtaining an API key for the first target application.

9. The method of claim 1, wherein the master API token is a bearer token.

10. The method of claim 1, wherein the master API token is a client credential token.

11. A method, implemented by a server, the method comprising:
receiving a first request to create a system session from a client, the first request comprising a master application programming interface (API) token;
generating a system session token for the system session in response to the first request;
receiving a second request to create a first application session for a first target application from the client, the second request comprising the master API token, the system session token, and a first identifier for the first target application;
creating the first application session in response to the second request;
receiving a third request to invoke a first API of the first target application from the client, the third request comprising the master API token, the system session token, the first identifier for the first target application, and a first payload for the first API; and
obtaining a first result from the first API of the first target application in response to the third request; and
forwarding the first result to the client.

12. The method of claim 11, wherein creating the first application session comprises:
validating the master API token and the system session token for the second request;
initiating the first application session with the first target application in response to validating the master API token and the system session token; and
storing information associating the first application session with the master API token and the system session token.

13. The method of claim 12, wherein initiating the first application session comprises:
authenticating with the first API through a simple redirect authentication workflow, an unsolicited security assertion markup language response authentication workflow, an identity provider initiated security assertion markup language authentication workflow, an identity provider initiated OAuth authorization code grant authentication workflow, or an API identifier token authentication workflow.

14. The method of claim 12, wherein the second request further comprises parameters for obtaining an API key for the first target application, and creating the first application session further comprises:
obtaining the API key based on the parameters.

15. The method of claim 14, wherein obtaining the first result from the first API of the first target application comprises:
validating the master API token and the system session token for the third request; and
invoking the first API based on the API key and the first payload.

16. The method of claim 11, further comprising:
generating the master API token for a user; and
associating the master API token with a rate limit and a session limit.

17. The method of claim 11, wherein the first payload for the first target application comprises a name for a method of the first API, a path for the method of the first API, and a parameter for the method of the first API.

18. The method of claim 11, wherein the master API token is a bearer token.

19. The method of claim 11, wherein the master API token is a client credential token.

20. A system comprising:
a client; and
a server comprising a processor and a non-transitory computer readable medium storing instructions which, when executed by the processor, cause the processor to:
receive a first request to create a system session from the client, the first request comprising a master application programming interface (API) token;
generate a system session token for the system session in response to the first request;
receive a second request to create a first application session for a first target application from the client, the second request comprising the master API token, the system session token, and a first identifier for the first target application;
create the first application session in response to the second request;
receive a third request to invoke a first API of the first target application from the client, the third request comprising the master API token, the system session token, the first identifier for the first target application, and a first payload for the first API; and
obtain a first result from the first API of the first target application in response to the third request; and
forward the first result to the client.
